(19) United States
(12) Patent Application Publication
(10) Pub. No.: US 2006/0047582 A1
(43) Pub. Date: Mar. 2, 2006

(54) On line shopping network that integrates with store-shopping

(76) Inventor: Jianfeng Jiang, San Jose, CA (US)

Correspondence Address: Jianfeng Jiang, 1149 El Prado Dr., San Jose, CA, 95120, US

(21) Appl. No.: 10/926,413

(22) Filed: Aug. 26, 2004

(51) Int. Cl. G07F 7/00

(52) U.S. Cl. 705/27

(57) ABSTRACT

An on-line shopping network with integrated store shopping includes at least one on-line provider of goods, a local server coupled to the at least one on-line provider of goods, a local network of terminals for displaying the provided goods, a user application software running on the local server, and a driver software application running on the local server.

### BACKGROUND OF THE INVENTION

The present invention relates to on-line shopping, on-line gaming, on-line entertainment and e-commerce.

The on-line shopping business has grown tremendously over the past several years. The famous websites include Amazon.com, Ebay.com, and Expedia.com to name a few. However, in the process of on-line shopping, the user must sit at a computer, click on categories and view several listings in each window. This is a far cry from the feeling of shopping in a physical store where a buyer can walk around the isles and see the many goods available. Especially with the expansion of the number of goods a vailable, the conventional on-line shopping is becoming complicated and boring.

There have been some attempts to use virtual reality technology to create three-dimensional images of stores with all the goods placed in isles, but none of these attempts have achieved any real store shopping effect upon the user.

There are also some products like “Web Kiosk”, which basically put actual computers in the stores, where the customers can search the web and purchase goods on-line using credit cards. However, these products are expensive and not easy to use, and are not efficient to handle many customers in real stores.

On the other hand, traditional stores have space limitations. Since all the real goods have to be displayed in the store, only a small amount of goods can be displayed.

As such there is a need in the art for an on-line shopping network with integrated store shopping. The on-line shopping network preferably allows store managers to search the web, select the goods customers might be interested in buying, and display the selections on monitors just like in physical stores in which all the goods are arranged in isles. Preferably the on-line shopping network allows shoppers to walk through the isles and see all the products selected. Further, the on-line shopping network preferably provides for a means by which once the shopper decides to buy a displayed product, the shopper can either pay with a credit card instantly or be given a code linked to the displayed product which the shopper can provide to a cashier for scanning. Preferably the on-line shopping network combines the benefits of both traditional store shopping and on-line shopping.

### SUMMARY OF THE INVENTION

In accordance with one aspect of the invention, the on-line shopping network with integrated store shopping allows store managers to search the web, select the goods customers might be interested in buying, and display the selections on monitors just like in physical stores in which all the goods are arranged in isles.

In accordance with another aspect of the invention, an on-line shopping network with integrated store shopping includes at least one on-line provider of goods, a local server coupled to the at least one on-line provider of goods, a local network of terminals for displaying the provided goods, a user application software running on the local server, and a driver software application running on the local server.

In accordance with yet another aspect of the invention, an on-line shopping network with integrated store shopping integrated with a point of sale system includes at least one on-line provider of goods, a local server coupled to the at least one on-line provider of goods, the local server coupled to the point of sale system, a local network of terminals for displaying the provided goods, a user application software running on the local server, and a driver software application running on the local server.

These and other features, aspects, and advantages of the present invention will become better understood with reference to the following drawings, description, and claims.

### BRIEF DESCRIPTION OF THE DRAWINGS

FIG. 1 is a schematic representation of the on-line shopping network with integrated store shopping in accordance with the invention.

### DETAILED DESCRIPTION OF THE INVENTION

The present invention relates to an on-line shopping network with integrated store shopping. The following description is presented to enable one of ordinary skill in the art to make and use the invention as provided in the context of a particular application and its requirements. Various modifications to the preferred embodiment will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

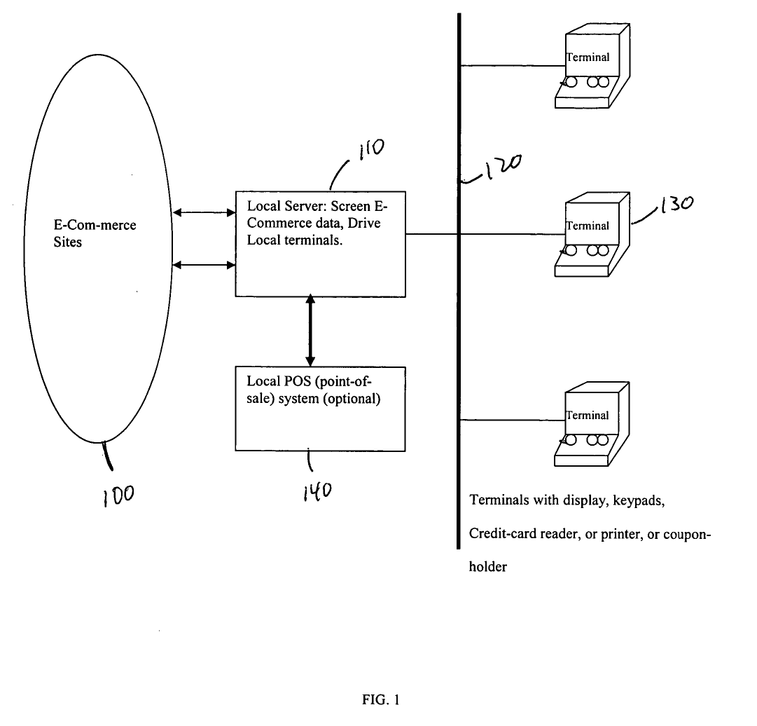

With reference to FIG. 1, the on-line shopping network with integrated store shopping may include at least one e-commerce site 100 such as Amazon.com or any other product provider or manufacturer having an on-line presence. A local server 110 may be coupled to the e-commerce site 100 by means of a distributed network such as the Internet. The local server 110 may control a local network 120 including a plurality of terminals 130 having input/output devices such as keypads, display monitors, credit card readers, printers and coupon holders.

User application software, by which a user can set criteria for data selection, such as which websites to choose from and which categories of information to retrieve may be operable to run on local server 110. The selected data may be saved in a memory of the local server for use by the local network 120.

A driver software application may control the local network 120. The driver software application may provide the user with options on how to display the data, such as which category to display on which terminal 130 and in what order the goods of each category may be displayed. Such decisions may be related to each user's retail selling strategy.

In this manner the on-line shopping network with integrated store shopping of the present invention combines the benefits of store shopping with the benefits of on-line shopping. A user such as a store manager can intelligently select and display goods his customers might be interested in and all the transactions may be done on-line with goods sent directly from the original on-line seller to the home of the buyer. The buyer does not have to sit around a computer in order to on-line shop. Furthermore, the on-line shopping network with integrated store shopping of the invention provides for the display of many more goods the buyer may not be aware of but may be interested in buying once the buyer sees the products displayed on the terminal 130.

In accordance with one aspect of the invention, a store manager may periodically run the user application software to select what categories and what goods are suitable for sale in a physical store. The data can then be stored in the local memory of the local server 110.

Based upon the store's retail strategy, the store manager may run a display option program to decide how to display the data on the local network 120 of terminals 130. For example, the store manager may decide whether to display all the categories of data on every terminal 130, or to display certain categories of data only related to the real goods that are being displayed near the terminal 130. Additionally, the store manager may decide the order of goods to be displayed in each category based upon the store strategy. For example, the store manager may display the items sold most in the beginner.

Each terminal 130 may include a printer and a coupon holder which may be used to give shoppers an identification of the goods they purchase through the terminal 130. The driver software application may assign an ID code to each good displayed. The ID code can be a traditional bar code or any other user defined code. Once a shopper purchases a good through a terminal 130, the printer may print out a ticket showing the identification of the good purchased. Preferably the ID code is scannable to make a check out process more convenient. The shopper may then bring the ticket to the cashier for check out. At check out, the cashier can either scan the ID code or manually type in the ID code in a point of sale (POS) system 140. The detailed information concerning the good purchased may be retrieved from the local server 110. The cashier may also verify the shopper's correct mailing address and mailing preferences to provide to the e-commerce site 100.

Alternatively, when printers are not available, a coupon holder may be provided with each terminal 130. The store manager may place coupons in each coupon holder. The local server 110 may include a record of all of the coupons placed at each terminal. Each coupon may include a unique identifying means such as a number. Once a shopper purchases an item at a terminal 130, a top coupon at the coupon holder may be ejected for the shopper to take to the cashier. The local server 110 may be operable to match the coupon ejected with the item purchase.

In another aspect of the invention, a credit card reader may be integrated with each terminal 130.

From each terminal 130, a shopper can select views of different categories of goods and view more detailed information about the goods displayed. The shopper may use the keypad for such navigation.

The terminals 130 may be wired to the local network 120. Alternatively a wireless system may be employed.

In use, a shopper may walk along isles having disposed therealong the terminals 130. The shopper may stop at a terminal 130 of interest and peruse the displayed categories of goods. If the shopper is interested in purchasing a displayed item, the shopper may either pay by credit card or be given a coupon or a ticket showing the ID code for the displayed item. The shopper may present the ticket or coupon to the cashier and check out.

The on-line shopping network with integrated store shopping of the invention may be implemented in a POS system comprising computer servers, monitors, bar-code readers, credit card reader and software to track goods, manage check in and check out, and analyze retail data. By using the on-line shopping network with integrated store shopping of the invention, managers may be equipped with a powerful tool to execute their retail strategy and dramatically increase store sales.

1-7. (canceled)

8. An on-line shopping network with integrated store shopping comprising:
at least one on-line provider of goods;
a local server coupled to the at least one on-line provider of goods;
a local network of terminals for displaying the provided goods;
a user application software running on the local server; and
a driver software application running on the local server.

9. The on-line shopping network of claim 8, wherein the terminals comprise a display monitor.

10. The on-line shopping network of claim 8, wherein the terminals comprise an input/output device.

11. The on-line shopping network of claim 10, wherein the input/output device comprises a touch screen.

12. The on-line shopping network of claim 8, wherein the terminals are disposed in a physical store.

13. The on-line shopping network of claim 8, wherein the local server is operable to control the local network and communicate with the at least one on-line provider of goods.

14. The on-line shopping network of claim 13, wherein the at least one on-line provider of goods comprises an e-commerce website accessible over a distributed network.

15. The on-line shopping network of claim 8, wherein the user application software comprises means for setting criteria for data selection by a user.

16. The on-line shopping network of claim 8, wherein the driver software application comprises controlling the local network of terminals.

17. The on-line shopping network of claim 8, wherein the local network of terminals comprise a credit card reader.

18. The on-line shopping network of claim 8, wherein the local network of terminals comprise an ID code dispenser.

19. The on-line shopping network of claim 18, wherein the ID code dispenser comprises a printer.

20. The on-line shopping network of claim 18, wherein the ID code dispenser comprises a coupon holder.

21. The on-line shopping network of claim 20, wherein the coupon holder comprises a box containing coupons preprinted with an ID code and ejectable from the box.

22. The on-line shopping network of claim 18, wherein an ID code comprises a bar code.

23. The on-line shopping network of claim 18, wherein an ID code comprises a user defined code.

24. An on-line shopping network with integrated store shopping integrated with a point of sale system comprising:
at least one on-line provider of goods;
a local server coupled to the at least one on-line provider of goods, the local server coupled to the point of sale system;
a local network of terminals for displaying the provided goods;
a user application software running on the local server; and
a driver software application running on the local server.

25. The on-line shopping network of claim 24, wherein the terminals comprise a display monitor.

26. The on-line shopping network of claim 24, wherein the terminals are disposed in a physical store.

27. The on-line shopping network of claim 24, wherein the local server is operable to control the local network and communicate with the at least one on-line provider of goods, wherein the at least one on-line provider of goods comprises an e-commerce website accessible over a distributed network, and wherein the user application software comprises means for setting criteria for data selection by a user.
